(19) United States
(12) Patent Application Publication
(10) Pub. No.: US 2025/0128643 A1
(43) Pub. Date: Apr. 24, 2025

(54) SELF-CONTAINED POWER UNIT FOR A WORK MACHINE

(71) Applicant: Caterpillar Underground Mining Pty. Ltd., South Burnie (AU)

(72) Inventors: Michael J. WOLFERT, Queensland (AU); Andrew E. DIECKER, Shorewell Park (AU); Alexander Eli DOWLING, Mt Hicks (AU)

(73) Assignee: Caterpillar Underground Mining Pty. Ltd., South Burnie (AU)

(21) Appl. No.: 18/491,547

(22) Filed: Oct. 20, 2023

(51) Int. Cl. B60L 58/24; B60L 50/60; B60L 53/80; B60L 58/20

(52) U.S. Cl. CPC B60L 58/24; B60L 50/66; B60L 53/80; B60L 58/20; B60L 2200/44

(57) ABSTRACT

A power unit may include an energy storage unit, a thermal management system configured to provide at least one of cooling or heating of the energy storage unit, and a low-voltage system. The low-voltage system may include a battery and one or more controllers, powered by the battery, configured to monitor and control the energy storage unit in both a connected state of the power unit and a disconnected state of the power unit. The power unit may include a power unit housing containing the energy storage unit, the thermal management system, and the low-voltage system. The power unit housing may be configured for removable connection to a frame of a machine.

### TECHNICAL FIELD

The present disclosure relates generally to work machines and, for example, to a self-contained power unit for a work machine.

### BACKGROUND

Diesel-powered work machines produce diesel particulates and emissions. In open work areas, the emissions from the diesel-powered work machines are dissipated into the atmosphere and do not accumulate around the work machine in high concentrations. In contrast, in closed work areas, such as mines, the emissions can build up within the closed work areas, and ventilation must be provided to prevent hazardous conditions. As an alternative to diesel-powered work machines, battery-powered electric drive work machines that produce zero emissions can be used for underground mining in order to reduce the need for mine ventilation. Electric drive work machines also produce less heat, such that the closed work area can remain cooler than with diesel powered work machines, thereby reducing the need for cooling systems.

Electric drive work machines may operate in remote locations, such as mines, where battery charging infrastructure is limited. Moreover, the process of recharging the batteries of such work machines can be time consuming. In some cases, a battery swap can be used to replenish the energy for an electric drive work machine when charging infrastructure is unavailable and/or to reduce downtime associated with recharging. In a battery swap, one or more spent or low-charge battery packs of a work machine may be disconnected from the work machine, and one or more charged battery packs may be connected to the work machine.

Generally, when a battery pack is connected to a work machine, the battery pack may be monitored and controlled to maintain a performance of the battery pack at a high level. However, when the battery pack is disconnected from the work machine, various functions implemented or controlled by the work machine may no longer be available for the battery pack. For example, the functions may include heating and/or cooling of the battery pack provided by a battery thermal management system, monitoring electrical and/or environmental characteristics of the battery pack, regulating or controlling electrical and/or environmental characteristics of the battery pack, or the like. Accordingly, when the battery pack is disconnected, the ability to monitor, regulate, and maintain a state of the battery pack may be lost. Furthermore, the process of disconnecting a used battery pack and connecting a new battery pack may be time consuming, thereby resulting in excessive machine downtime. Generally, in a battery swap, a battery pack disconnected from a work machine lacks the ability to maintain its health and environment while disconnected from the work machine (e.g., before, during, and after re-charging of the battery pack).

The power unit of the present disclosure solves one or more of the problems set forth above and/or other problems in the art.

### SUMMARY

A power unit may include an energy storage unit, a thermal management system configured to provide at least one of cooling or heating of the energy storage unit, and a low-voltage system. The low-voltage system may include a battery and one or more controllers, powered by the battery, configured to monitor and control the energy storage unit in both a connected state of the power unit and a disconnected state of the power unit. The power unit may include a power unit housing containing the energy storage unit, the thermal management system, and the low-voltage system. The power unit housing may be configured for removable connection to a frame of a machine.

A machine may include a frame and a power unit connected to the frame. The power unit may include an energy storage unit, a thermal management system configured to provide at least one of cooling or heating of the energy storage unit, and a low-voltage system. The low-voltage system may include a battery and one or more controllers, powered by the battery, configured to monitor and control the energy storage unit in both a connected state of the power unit and a disconnected state of the power unit. The power unit may include a power unit housing containing the energy storage unit, the thermal management system, and the low-voltage system. The power unit housing may be configured for removable connection to the frame.

A power unit may include an energy storage unit, a thermal management system configured to provide at least one of cooling or heating of the energy storage unit, and a power unit housing containing the energy storage unit and the thermal management system. The power unit housing may be configured for removable connection to a frame of a machine.

### BRIEF DESCRIPTION OF THE DRAWINGS

FIG. 1 is a perspective view of an example machine.

FIG. 2 is a diagram of an example power unit.

FIG. 3 is a perspective view of an example power unit.

FIG. 4 is a perspective view of an example power unit.

### DETAILED DESCRIPTION

This disclosure relates to a power unit, which is applicable to any machine that utilizes an electric drive.

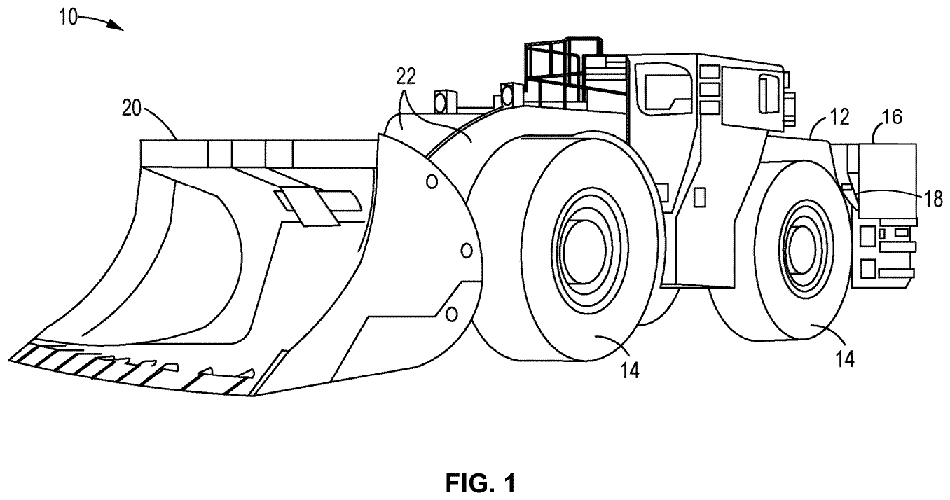

FIG. 1 is a perspective view of an example machine 10. The machine 10 may be a work machine. For example, the machine 10 may perform earth moving, excavation, or another operation associated with an industry, such as mining. As an example, as illustrated in FIG. 1, the machine 10 is an underground mining machine, such as an underground load-haul-dump (LHD) loader. In some examples, the machine 10 is a different type of underground mining machine, such as an underground articulated truck (UAT). However, the machine 10 may be another type of machine, such as a compactor machine, a paving machine, a cold planer, a grading machine, a backhoe loader, a wheel loader, a harvester, an excavator, a motor grader, a skid steer loader, a tractor, or a dozer, among other examples. The machine 10 is an electric drive machine (e.g., that is battery powered).

The machine 10 may include a frame 12 supported by a plurality of ground-engaging members 14, which are illustrated as wheels. Additionally, or alternatively, the ground-engaging members 14 may include track assemblies, skids, or the like. The ground-engaging members 14 are used to propel the machine 10 over a work surface. In some examples, the frame 12 may include an articulated joint (not shown) to allow a front frame portion and a rear frame portion to pivot with respect to each other. The machine 10 includes a power unit 16, connected to the frame 12, to provide power to the ground-engaging members 14 via an electromechanical drivetrain 18. For example, the power unit 16 may provide power to an electric motor (not shown) of the machine 10. The machine 10 may further include an implement 20 mounted to the frame 12 that may be used to manipulate and/or transport work material at a worksite. For example, the implement 20 may be mounted to the frame 12 by a pair of lift arms 22. The implement 20 may include a bucket, as shown. In some implementations, the power unit 16 may provide power to the implement 20 (e.g., via a hydraulic system). In some examples, the implement 20 may include a bed, or dump body, pivotally connected to the frame 12.

As indicated above, FIG. 1 is provided as an example. Other examples may differ from what is described with regard to FIG. 1.

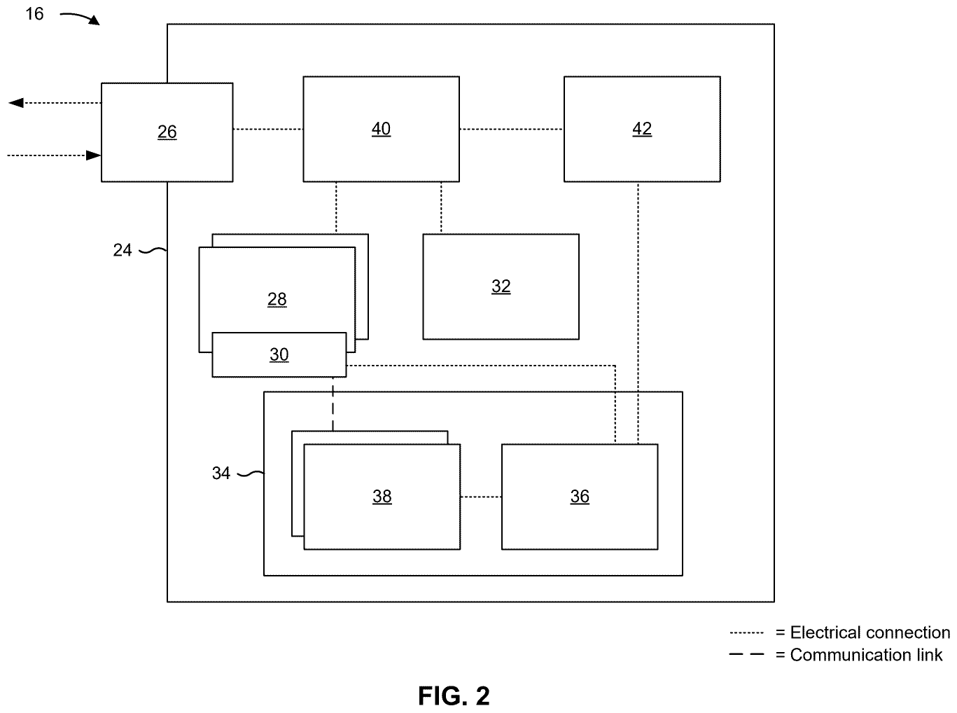

FIG. 2 is a diagram of an example of the power unit 16. As shown, the power unit 16 includes a power unit housing 24. The power unit housing 24 is a box-shaped container defining an interior cavity configured to contain the components of the power unit 16, described herein. The power unit housing 24 may be impact-resistant to protect the components contained in the power unit housing 24. For example, the power unit housing 24 may be configured as a falling object protective structure (FOPS). The power unit housing 24 is configured for removable connection to the frame 12 of the machine 10. For example, the power unit housing 24 may include one or more connection elements (not shown) that can be coupled and uncoupled to one or more connection elements (not shown) on the frame 12. In this way, the power unit 16 can be disconnected from the machine 10 (e.g., as a unit) or connected to the machine 10 (e.g., as a unit) in connection with a power unit replacement.

The power unit 16 includes a power interface connector 26 (e.g., a high-voltage connector) contained in the power unit housing 24. The power unit housing 24 may be configured to expose at least a portion of the power interface connector 26 to allow wired connection to the power unit 16 via the power interface connector 26. For example, the power interface connector 26 is configured to electrically connect the power unit 16 to an external load or an external power source (e.g., external relative to the power unit 16). The external load may be one or more components of the machine 10, such as an electric motor of the machine 10. The external power source may be a high-voltage power source (e.g., a charger). A data link for the power unit 16 may also be provided via the power interface connector 26. The power unit 16 may be in a “connected state” when the power unit 16 is connected to an external load or an external power source via the power interface connector 26. The power unit 16 may be in a “disconnected state” when the power unit 16 is not connected to an external load or an external power source via the power interface connector 26.

The power unit 16 includes one or more energy storage units 28 contained in the power unit housing 24. The energy storage units 28 may be high-voltage power sources (e.g., 500 volts (V) or more nominal voltage, or 700 V or more nominal voltage). An energy storage unit 28 may include a battery cell, a battery module, a battery pack, a fuel cell, or the like. In some examples, the power unit 16 includes two battery packs (e.g., including battery cells, such as lithium ion battery cells). The energy storage units 28 may include a control system 30. The control system 30 may include one or more sensors and/or one or more controllers configured to control operation of the energy storage units 28 (e.g., cause turning on or turning off of the energy storage units 28) and/or monitor electrical characteristics (e.g., current, voltage, state of charge, or the like) and/or environmental characteristics (e.g., temperature, humidity, or the like) associated with the energy storage units 28.

The power unit 16 includes a thermal management system 32 (e.g., a battery thermal management system (BTMS)) contained in the power unit housing 24. The thermal management system 32 is configured to provide cooling and/or heating to the energy storage units 28. For example, in connection with cooling, the thermal management system 32 may include a condenser (e.g., having one or more fans), a compressor, a coolant tank, a coolant pump, a chiller, an evaporator, and/or a dryer. As another example, in connection with heating, the thermal management system 32 may include a heater. The thermal management system 32 may include one or more sensors and/or one or more controllers configured to monitor characteristics of the thermal management system 32 and/or control operation of the thermal management system 32 (e.g., cause turning on or turning off of components of the thermal management system 32).

The power unit 16 includes a low-voltage system 34 contained in the power unit housing 24. The low-voltage system 34 is configured to monitor and/or control the energy storage units 28. For example, the low-voltage system 34 may be configured to monitor and/or control the energy storage units 28 both in a connected state of the power unit 16 and in a disconnected state of the power unit 16 (e.g., regardless of whether the power unit 16 is in a connected state or in a disconnected state).

The low-voltage system 34 may include a battery 36 (e.g., one or more batteries 36) and one or more controllers 38 (e.g., electronic control modules (ECMs)). The battery 36 may be a low-voltage power source (e.g., 24 V or less nominal voltage). In particular, the battery 36 may be low-voltage relative to the energy storage units 28. The battery 36 may be a lead-acid battery. A controller 38 may include one or more memories, one or more processors, and/or a communication component (e.g., a transceiver). The controllers 38 may be electrically connected to the battery 36. Thus, the controllers 38 may be powered by the battery 36. Additionally, the control system 30 may be electrically connected to the battery 36. The low-voltage system 34 can power the control system 30 using the battery 36 in both a connected state and a disconnected state of the power unit 16. Further, the controller(s) 38 may be communicatively connected to the control system 30, thereby enabling the exchange of information (e.g., data, commands, or the like) between the controller(s) 38 and the control system 30 (e.g., between the controller(s) 38 and sensors and/or controllers of the control system 30).

In a connected state of the power unit 16, the controller(s) 38 may cause the energy storage units 28 to turn on. For example, in a connected state of the power unit 16, the controller(s) 38 may issue a command to the control system 30 to power on the energy storage units 28. The energy storage units 28 may then supply current to the battery 36 to recharge the battery 36 (e.g., the controller(s) 38 may cause the energy storage units 28 to charge the battery 36 in a connected state of the power unit 16). Furthermore, in the connected state, the controller(s) 38 may monitor the energy storage units 28. In a disconnected state of the power unit 16, the energy storage units 28 may not be powered on. However, even in the disconnected state, the controller(s) 38 may monitor the energy storage units 28. For example, the battery 36 may power the controller(s) 38 and the control system 30 in both the connected state and the disconnected state of the power unit 16 to facilitate continuous monitoring of the energy storage units 28.

To monitor the energy storage units 28, the controller(s) 38 may obtain monitoring data from the control system 30 (e.g., in both a connected state and a disconnected state of the power unit 16). For example, one or more sensors of the control system 30 may collect the monitoring data, and one or more controllers of the control system 30 may output the monitoring data to the controller(s) 38. The monitoring data may relate to a current of the energy storage units 28, a voltage of the energy storage units 28, a resistance of the energy storage units 28, a quantity of charge-discharge cycles of the energy storage units 28, a temperature of the energy storage units 28, and/or a humidity of the energy storage units 28, among other examples. Using the monitoring data, the controller(s) 38 may monitor and/or determine a state of charge (SOC), a state of health (SOH), a depth of discharge (DOD), an output voltage, a temperature, a humidity, and/or an internal resistance and impedance of the energy storage units 28, among other examples.

The controller(s) 38 may output information, derived using the monitoring data, offboard the power unit 16 (e.g., in both a connected state and a disconnected state of the power unit 16). The information may relate to characteristics of the energy storage units 28, such as the characteristics monitored and/or determined by the controller(s) 38 described above. The information may be for presentation in a user interface associated with the machine 10 and/or a user device, thereby allowing operators to monitor the energy storage units 28 both when the power unit 16 is connected to the machine 10 and when the power unit 16 is disconnected from the machine 10 (e.g., before, during, and after recharging of the energy storage units 28).

In addition, the low-voltage system 34 may control other systems of the power unit 16 responsive to the monitoring data and/or characteristics of the energy storage units 28 derived using the monitoring data. For example, the controller(s) 38 may control the thermal management system 32 responsive to monitoring characteristics of an environment of the energy storage units 28 (e.g., a temperature, a humidity, or the like). As an example, the controller(s) 38 may cause cooling components and/or heating components of the thermal management system 32 to turn on, to turn off, to increase in intensity, to decrease in intensity, or the like. In some examples, the controller(s) 38 may cause activation of components of the thermal management system 32 when the power unit 16 is in the connected state, but not when the power unit 16 is in the disconnected state.

In some implementations, the controller(s) 38 may receive an operator input indicating a command for the power unit 16. For example, the command may indicate that charging of the energy storage units 28 is to be started or stopped, that components of the thermal management system 32 are to be activated or deactivated, or the like. Accordingly, the controller(s) 38 may execute the command (e.g., by issuing a command to the control system 30 and/or the thermal management system 32). In this way, the power unit 16 facilitates operator control both when the power unit 16 is connected to the machine 10 and when the power unit 16 is disconnected from the machine 10 (e.g., before, during, and after recharging of the energy storage units 28).

In some examples, the low-voltage system 34 may include a low-voltage fuse box (not shown in FIG. 2) for the controllers 38 and/or other components of the low-voltage system 34. In some examples, the low-voltage system 34 may include an emergency stop component (not shown in FIG. 2). The emergency stop component may be a button, a switch, a lever, or the like. When the emergency stop component is activated (e.g., manually activated), the controller(s) 38 may issue a command to the control system 30 and/or the thermal management system 32 that causes deactivation of the energy storage units 28 and/or deactivation of components of the thermal management system 32.

The power unit 16 includes a power distribution unit 40 contained in the power unit housing 24. The power distribution unit 40 is electrically connected to the energy storage units 28, to the thermal management system 32, and/or to the low-voltage system 34 (e.g., to the battery 36 via a voltage converter 42 contained in the power unit housing 24). The power distribution unit 40 is configured to distribute power (e.g., high-voltage power) among the energy storage units 28, the thermal management system 32, and/or the low-voltage system 34. During charging of the energy storage units 28 (e.g., when the power unit 16 is connected to a charger), the power distribution unit 40 may distribute high-voltage power, input at the power interface connector 26 and/or discharged by the energy storage units 28, to the energy storage units 28, to high-voltage components of the thermal management system 32 (e.g., the condenser, the compressor, the coolant pump, the heater, the dryer, and/or the voltage converter 42), and/or to the low-voltage system 34 (e.g., to the battery 36) via the voltage converter 42 (e.g., which converts the high voltage to the low voltage used by the low-voltage system 34). During discharging of the energy storage units 28 (e.g., when the power unit 16 is connected to the machine 10), the power distribution unit 40 may distribute high-voltage power, discharged by the energy storage units 28, to high-voltage components of the thermal management system 32 and/or to the low-voltage system 34 (e.g., to the battery 36) via the voltage converter 42. In some examples, the power unit 16 may include a high-voltage fuse box (not shown in FIG. 2), contained in the power unit housing 24, for the high-voltage components of the thermal management system 32.

The power distribution unit 40 may include contactors configured to prevent (e.g., by opening) a live direct current (DC) bus from being present on external touchable surfaces of the power unit 16 (e.g., when the power unit 16 is not connected to the machine 10). Additionally, the contactors may be configured to facilitate realignment of one or more DC busses of the power unit 16 to join a link with the machine 10 (e.g., when the power unit is connected to the machine 10). The contactors also may be configured as an absence of voltage (AOV) checkpoint.

In some examples, the power unit 16 may include high-voltage lamps configured to indicate a voltage present on a DC bus of the power unit 16. The power unit 16 also may include a ground fault detection system configured to monitor for and/or detect a ground fault of the power unit 16. The ground fault detection system may be selectively enabled or disabled in accordance with whether the power unit 16 is connected to the machine 10 or connected to an external power source (e.g., a charger). In some examples, the power unit 16 may include one or more lockouts (or isolators) configured to electrically isolate the low-voltage system 34 and/or to electrically isolate a high-voltage system of the power unit 16.

The power unit 16, which contains the energy storage units 28, the thermal management system 32, and the low-voltage system 34, among other components, in the power unit housing 24, is a self-contained machine that can operate independently from the machine 10. Thus, the power unit 16 facilitates monitoring and control of the energy storage units 28 and their environment even when the power unit 16 is not connected to the machine 10. For example, the power unit 16 may be disconnected from the machine 10 (e.g., when the energy storage units 28 have a low charge), and replaced with a new power unit, in order to recharge the power unit 16. During this time period when the power unit 16 is not connected to any machine 10, a state and/or a performance of the energy storage units 28 can still be monitored and/or maintained.

As indicated above, FIG. 2 is provided as an example. Other examples may differ from what is described with regard to FIG. 2.

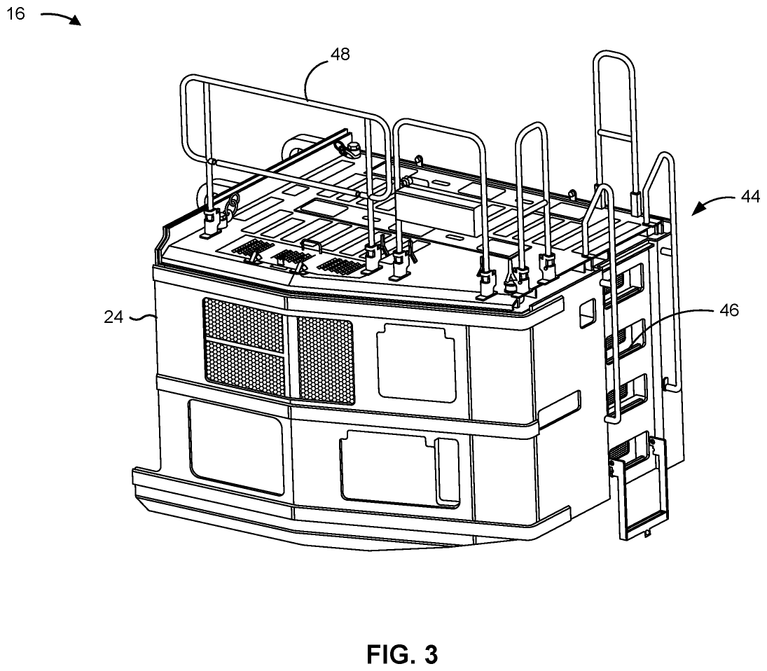

FIG. 3 is a perspective view of an example of the power unit 16. As shown, the power unit 16 may include an access system 44. The access system 44 may facilitate access to a top surface of the power unit housing 24, thereby allowing servicing of the power unit 16. The access system 44 may include a ladder 46 leading to the top surface of the power unit housing 24. The ladder 46 may be defined in the power unit housing 24 (as shown), or may be a separate component that is attached to the power unit housing 24. The access system 44 may also include one or more safety rails 48 surrounding the top surface of the power unit housing 24. As further shown in FIG. 3, the power unit housing 24 may have one or more openings in walls of the power unit housing 24 to provide ventilation and/or access to components contained in the power unit housing 24.

As indicated above, FIG. 3 is provided as an example. Other examples may differ from what is described with regard to FIG. 3.

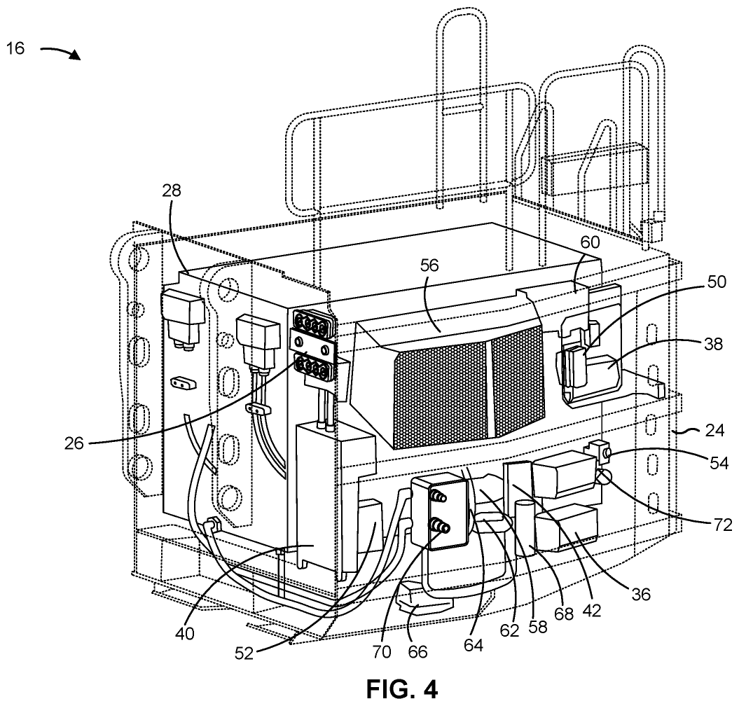

FIG. 4 is a perspective view of an example of the power unit 16. In FIG. 4, the power unit housing 24 is shown as translucent to reveal the components contained in the power unit housing 24. FIG. 4 shows, contained in the power unit housing 24, the power interface connector 26, the energy storage units 28 (e.g., battery packs), the battery 36 of the low-voltage system 34, the controllers 38 of the low-voltage system 34, the low-voltage fuse box 50, the power distribution unit 40, the voltage converter 42, the high-voltage fuse box 52, the emergency stop component 54, and an isolator 72 for the low-voltage system 34. Furthermore, FIG. 4 shows, contained in the power unit housing 24, components of the thermal management system 32, including the condenser 56, the compressor 58, the coolant tank 60, the coolant pump 62, the chiller or evaporator 64, the heater 66, and the dryer 68. Additionally, as shown in FIG. 4, the power unit 16 may include one or more offboard thermal management system connections 70. The connections 70 (e.g., quick-connect couplers) are configured to connect an external cooling source and/or an external heating source to the power unit 16 (e.g., for supplemental cooling or heating, if needed).

As indicated above, FIG. 4 is provided as an example. Other examples may differ from what is described with regard to FIG. 4. For example, FIG. 4 shows an example arrangement of the components of the power unit 16. Other arrangements from that shown in FIG. 4 may be used in practice.

### INDUSTRIAL APPLICABILITY

The power unit described herein may be used with any machine that utilizes an electric drive. For example, the power unit may be used with a battery-powered work machine, such as an underground mining machine. Generally, when an energy storage unit (e.g., a battery pack) is connected to a work machine, the energy storage unit may be monitored and controlled to maintain a performance of the energy storage unit at a high level. However, when the energy storage unit is disconnected from the work machine, various functions implemented or controlled by the work machine may no longer be available for the energy storage unit. Accordingly, when the energy storage unit is disconnected, the ability to monitor, regulate, and maintain a state of the energy storage unit may be lost.

The power unit described herein is useful for maintaining a state of an energy storage unit when the energy storage unit is disconnected from a work machine. In particular, the power unit enables monitoring and control of the energy storage unit when the energy storage unit is disconnected from a work machine, such as while the energy storage unit is awaiting recharging, while the energy storage unit is being recharged, and/or while the recharged energy storage unit is awaiting connection back to the work machine or another work machine. For example, the power unit, which contains one or more energy storage units, a thermal management system for the energy storage units, and a low-voltage system to control monitoring of the energy storage units and offboard communications, is a self-contained machine that can operate independently from a work machine. Thus, during a time period when the power unit is not connected to any work machine, a state of the energy storage units can still be monitored and/or maintained, thereby improving an overall health and performance of the energy storage units. Moreover, the power unit may be disconnected and connected to a work machine via a single power interface connector (e.g., that provides an electrical connection as well as a data link), thereby facilitating fast and efficient power unit replacement and reducing machine downtime.

What is claimed is:

1. A power unit, comprising:
an energy storage unit;
a thermal management system configured to provide at least one of cooling or heating of the energy storage unit;
a low-voltage system, comprising:
a battery; and
one or more controllers, powered by the battery, configured to monitor and control the energy storage unit in both a connected state of the power unit and a disconnected state of the power unit; and
a power unit housing containing the energy storage unit, the thermal management system, and the low-voltage system,
the power unit housing configured for removable connection to a frame of a machine.

2. The power unit of claim 1, further comprising a power interface connector configured to electrically connect the power unit to an external load or an external power source.

3. The power unit of claim 1, wherein the one or more controllers are configured to obtain monitoring data from a control system of the energy storage unit in both the connected state of the power unit and the disconnected state of the power unit.

4. The power unit of claim 3, wherein the one or more controllers are configured to output information, derived using the monitoring data, offboard the power unit in both the connected state of the power unit and the disconnected state of the power unit.

5. The power unit of claim 3, wherein the one or more controllers are configured to control the thermal management system responsive to the monitoring data.

6. The power unit of claim 1, wherein the one or more controllers are configured to cause the energy storage unit to turn on in the connected state of the power unit.

7. The power unit of claim 1, wherein the one or more controllers are configured to cause the energy storage unit to charge the battery in the connected state of the power unit.

8. The power unit of claim 1, further comprising a power distribution unit, contained in the power unit housing, configured to distribute power among the thermal management system, the low-voltage system, and the energy storage unit.

9. The power unit of claim 8, wherein the power distribution unit is configured to distribute power to the low-voltage system via a voltage converter contained in the power unit housing.

10. A machine, comprising:
a frame; and
a power unit connected to the frame, the power unit comprising:
an energy storage unit;
a thermal management system configured to provide at least one of cooling or heating of the energy storage unit;
a low-voltage system, comprising:
a battery; and
one or more controllers, powered by the battery, configured to monitor and control the energy storage unit in both a connected state of the power unit and a disconnected state of the power unit; and
a power unit housing containing the energy storage unit, the thermal management system, and the low-voltage system,
the power unit housing configured for removable connection to the frame.

11. The machine of claim 10, wherein the one or more controllers are configured to obtain monitoring data from a control system of the energy storage unit in both the connected state of the power unit and the disconnected state of the power unit.

12. The machine of claim 11, wherein the one or more controllers are configured to output information, derived using the monitoring data, offboard the power unit in both the connected state of the power unit and the disconnected state of the power unit.

13. The machine of claim 11, wherein the one or more controllers are configured to control the thermal management system responsive to the monitoring data.

14. A power unit, comprising:
an energy storage unit;
a thermal management system configured to provide at least one of cooling or heating of the energy storage unit; and
a power unit housing containing the energy storage unit and the thermal management system,
the power unit housing configured for removable connection to a frame of a machine.

15. The power unit of claim 14, wherein the thermal management system comprises one or more of a condenser, a compressor, a coolant tank, a coolant pump, a chiller, an evaporator, or a dryer.

16. The power unit of claim 14, wherein the thermal management system comprises a heater.

17. The power unit of claim 14, further comprising a power interface connector configured to electrically connect the power unit to an external load or an external power source.

18. The power unit of claim 14, further comprising a low-voltage system, comprising:
a battery; and
one or more controllers powered by the battery.

19. The power unit of claim 18, wherein the one or more controllers are configured to obtain monitoring data from a control system of the energy storage unit in both a connected state of the power unit and a disconnected state of the power unit.

20. The power unit of claim 18, wherein the low-voltage system is configured to power a control system of the energy storage unit using the battery in both a connected state of the power unit and a disconnected state of the power unit.
